(19) United States
(12) Patent Application Publication
(10) Pub. No.: US 2012/0125645 A1
(43) Pub. Date: May 24, 2012

(54) ELECTRONIC DEVICE AND FIRE MONITORING METHOD USING THE ELECTRONIC DEVICE

(75) Inventors: SHEN-CHUN LI, Tu-Cheng (TW); HSIEN-CHUAN LIANG, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/195,854

(22) Filed: Aug. 2, 2011

(30) Foreign Application Priority Data
Nov. 18, 2010 (TW) 99139839

(51) Int. Cl. A62C 35/02; A62C 2/00

(52) U.S. Cl. 169/46; 169/26; 169/52

(57) ABSTRACT

An electronic device performs a fire monitoring method in where the electronic device controls a mobile platform to move along a predetermined path, to capture the temperature distribution of an area to be monitored by an infrared capturing device, and detect a consistency of a flammable chemical substance with a smoke detector. The electronic device determines whether the area meets fire conditions by detecting whether the temperature distribution complies with a predetermined temperature distribution, or by detecting whether the consistency is greater than a predefined value. If the area meets the fire conditions, the electronic device determines a fire position, selects one fire extinguisher from the mobile platform to extinguish the fire position.

### BACKGROUND

1. Technical Field

Embodiments of the present disclosure generally relate to fire fighting devices and methods, particularly to an electronic device and a fire monitoring method using the electronic device.

2. Description of Related Art

Fire monitoring and suppression systems have been previously proposed in a plethora of different methods and devices to either monitor and suppress or otherwise completely soak a structure. Typical of the existing art in this field is that the fire can be detected by measuring temperature and smoke; however, this system has many flaws including not being timely enough. Therefore, an improved fire monitoring and suppression system and method is desirable to address the aforementioned issues.

### BRIEF DESCRIPTION OF THE DRAWINGS

FIG. 1 is a block diagram of one embodiment of an electronic device including a fire monitoring unit.

FIG. 2 is a block diagram of one embodiment of function modules of the fire monitoring unit of FIG. 1.

FIG. 3 is a flowchart illustrating one embodiment of a fire monitoring method using the electronic device of FIG. 1.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device. Depending on the embodiment, the non-transitory readable medium may be a hard disk drive, a compact disc, a digital video disc, a tape drive or other suitable storage media.

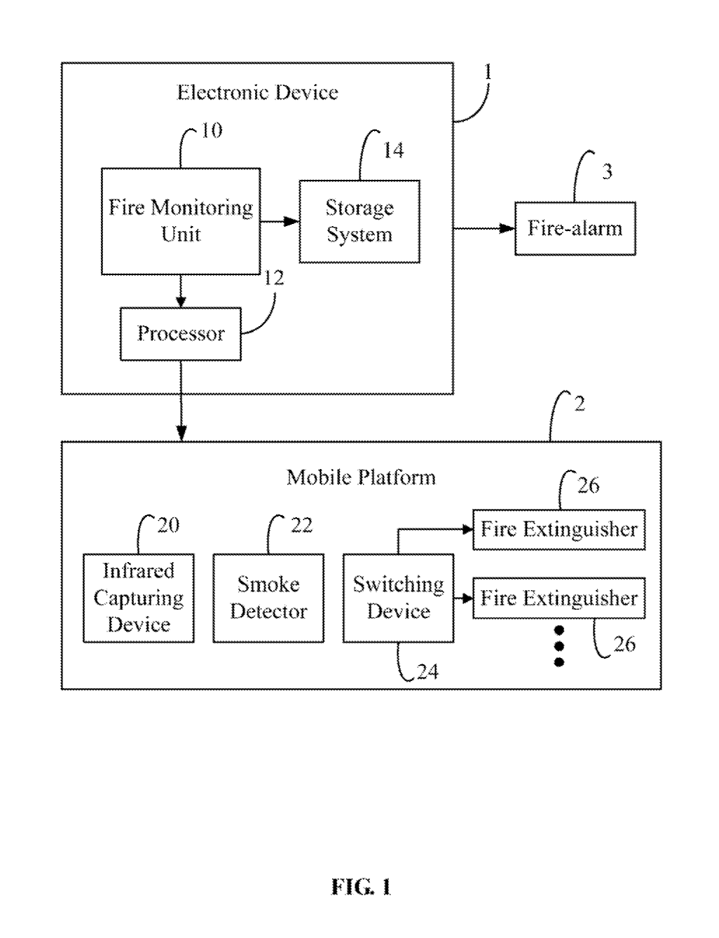

FIG. 1 is a block diagram of one embodiment of an electronic device 1 including a fire monitoring unit 10. In the embodiment, functions of the fire monitoring unit 10 are implemented by the electronic device 1. The electronic device 1 is electronically connected to a mobile platform 2. The fire monitoring unit 10 can control the mobile platform 2 to detect whether an area such as a room meets fire conditions, and extinguishes (or suppresses) the fire if the area meets the fire conditions. The fire conditions may include a temperature distribution of the area that does not comply with a predetermined temperature distribution, and consistencies of flammable chemical substances in the area that are greater than a corresponding predefined value. In the embodiment, the electronic device 1 is further electronically connected to a fire-alarm 3, which is used for generating an alarm to forewarn of the risk of fire.

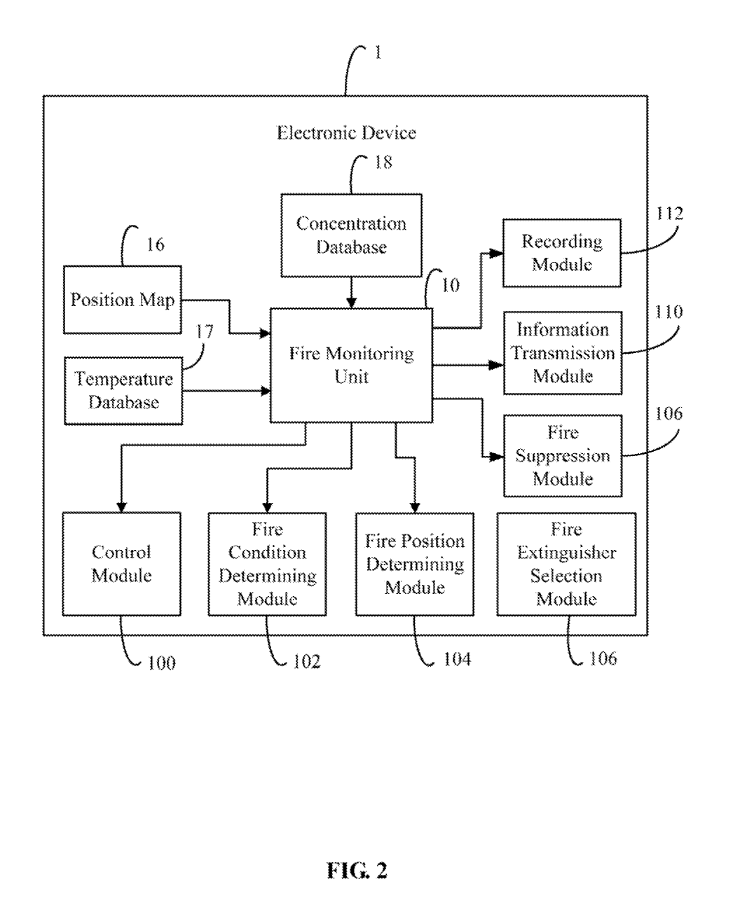

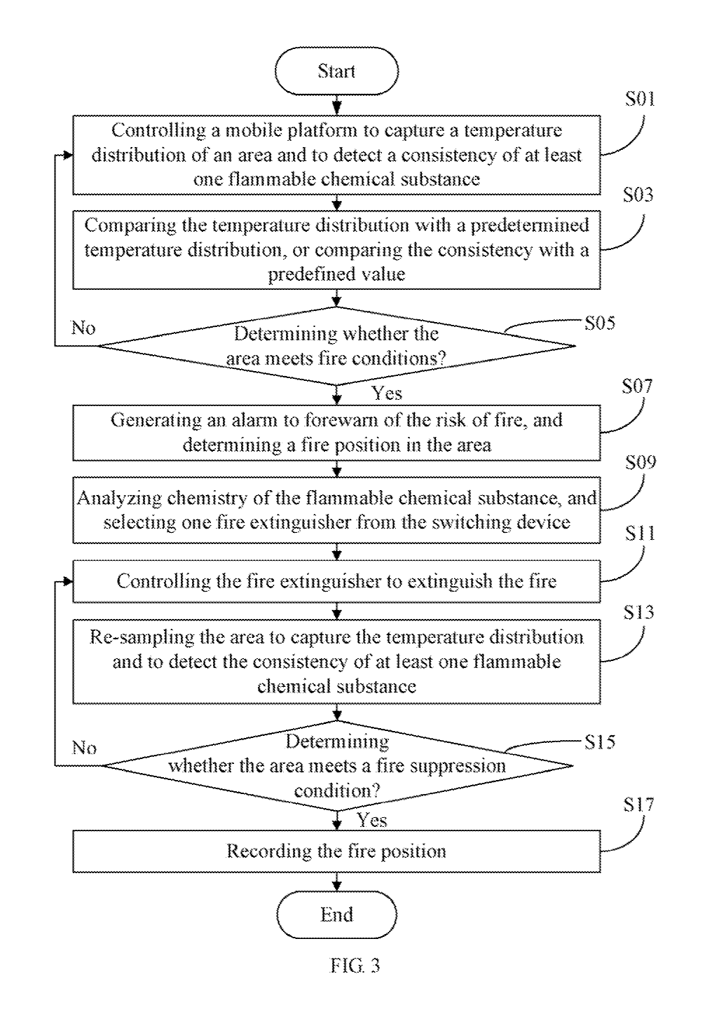

In the embodiment, the mobile platform 2 is a mechanical structure that is mounted on a track, and moves along the track to monitor the area. The track is set above the area. For example, the track can be mounted to a ceiling of a room to be monitored. The mobile platform 2 is installed with an infrared capturing device 20, a smoke detector 22, and a switching device 24 with one or more fire extinguishers 26. Functions of the infrared capturing device 20, the smoke detector 22, and the switching device 24 are detailed in FIG. 2 and FIG. 3.

In one embodiment, the electronic device 1 may be a computer, a server, a portable electronic device, or any other electronic device that includes a storage system 12 and at least one processor 14. The processor may be a central processing unit or a math coprocessor, for example.

FIG. 2 is a block diagram of one embodiment of function modules of the fire monitoring unit 10 of FIG. 1. In one embodiment, the fire monitoring and unit 10 includes a control module 100, a fire condition determining module 102, a fire position determining module 104, a fire extinguisher selection module 106, a fire suppression module 108, a information transmission module 110, and a recording module 112. Each of the modules 100-118 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

In the embodiment, the electronic device 1 further includes a position map 16, a temperature database 17, and a consistency database 18.

The control module 100 controls the mobile platform 2 to move along the track according to a predetermined path, to capture a temperature distribution of an area to be monitored (i.e., a room) by the infrared capturing device 20, and to detect smoke with the smoke detector 22. For example, the smoke detector 22 detects a consistency of at least one flammable chemical substance in the smoke.

The fire condition determining module 102 determines whether the room meets the fire conditions by detecting whether the temperature distribution complies with a predetermined temperature distribution in the temperature database 17, or by detecting whether the consistency of the at least one flammable chemical substance is greater than a predefined value in the consistency database 18. In the embodiment, the predetermined temperature may be preset as forty degrees Celsius.

When the area meets the fire conditions, the information transmission module 110 sends a fire alarm information to the fire-alarm 3, and the fire-alarm 3 generates an alarm to forewarn of the risk of fire. At the same time, the fire position determining module 104 determines a fire position in the area according to planimetric position of the room, the captured temperature distribution, and the consistency of the flammable chemical substance. In the embodiment, the planimetric position of the room can be found from the position map 16.

The fire extinguisher selection module 106 analyzes chemistry of the at least one flammable chemical substance according to the consistency of the at least one flammable chemical substance, and selects one fire extinguisher 26 from the switching device 24.

The fire suppression module 108 controls the fire extinguisher 26 to extinguish the fire at the fire position. After extinguishing the fire, the control module 100 re-sampling the room, captures the temperature distribution of the room by using the infrared capturing device 20, and detects the consistency of the at least one flammable chemical substance by using the smoke detector 22. The fire condition determining module 102 determines whether the room meets a fire suppression condition according to the temperature distribution and the consistency.

If the room meets the fire suppression condition, the recording module 112 records the fire position in the storage system 14.

If the room does not meet the fire suppression condition, the information transmission module 110 sends the fire alarm information to the fire-alarm 3 to keep ringing, and the fire suppression module 108 controls the fire extinguisher 26 to extinguish the fire at the fire position. In another embodiment, if the fire extinguisher 26 is fully discharged and the room does not meet the fire suppression condition, the control module 100 controls the mobile platform 2 to move to a safer place, for example, moving out of the room.

FIG. 3 is a flowchart illustrating one embodiment of a fire monitoring method using the electronic device 1. Depending on the embodiment, additional blocks may be added, others removed, and the ordering of the blocks may be changed.

In block S01, the control module 100 controls the mobile platform 2 to move along the track according to a predetermined path, to capture a temperature distribution of a room with the infrared capturing device 20, and to detect a consistency of at least one flammable chemical substance by the smoke detector 22.

In block S03, the fire condition determining module 102 compares the temperature distribution with a predetermined temperature distribution stored in the temperature database 17, and compares the consistency of the at least one flammable chemical substance with a predefined value in the consistency database 18, to determines whether the room meets the fire conditions in block S05. If the room meets the fire conditions, block S07 is implemented. If the room does not meet the fire conditions, block S01 is repeated.

For example, if the temperature distribution does not comply with the predetermined temperature distribution, or the consistency of the at least one flammable chemical substance is greater than the predefined value, the fire condition determining module 102 determines that the room meets the fire conditions. If the temperature distribution complies with the predetermined temperature distribution, and the consistency of the at least one flammable chemical substance is not greater than the predefined value, the fire condition determining module 102 determines that the room does not meet the fire conditions.

In block S07, the information transmission module 110 sends fire alarm information to the fire-alarm 3 for generating an alarm to forewarn of the risk of fire. The fire position determining module 104 determines a fire position in the room according to the planimetric position of the room, the temperature distribution, and the consistency of the flammable chemical substance. In the embodiment, the planimetric position of the room can be found from the position map 16.

In block S09, the fire extinguisher selection module 106 analyzes chemistry of the at least one flammable chemical substance according to the consistency of the at least one flammable chemical substance, and selects one fire extinguisher 26 from the switching device 24.

In block S11, the fire suppression module 108 controls the fire extinguisher 26 to extinguish the fire at the fire position.

In block S13, the control module 100 re-samples the room, captures the temperature distribution of the room by using the infrared capturing device 20, and detects the consistency of the at least one flammable chemical substance by using the smoke detector 22.

In block S15, the fire condition determining module 102 determines whether the room meets a fire suppression condition by determining whether the further temperature distribution complies with the predetermined temperature distribution, and by determining whether the consistency is greater than the predefined value. If the room meets the fire suppression condition, block S17 is implemented. Otherwise, if the room does not meet the fire suppression condition, the block S11 is implemented, and the information transmission module 110 sends the fire alarm information to the fire-alarm 3 to keep ringing.

In block S17, the recording module 112 records the fire position in the storage system 14.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring method using an electronic device, comprising:
(a) controlling a mobile platform to move along a predetermined path, the mobile platform comprising an infrared capturing device, a smoke detector, and one or more fire extinguishers, the infrared capturing device capturing a temperature distribution of an area monitored by an infrared capturing device, the smoke detector detecting consistency of at least one flammable chemical substance in the area;
(b) determining whether the area meets fire conditions by detecting whether the temperature distribution complies with a predetermined temperature distribution, or by detecting whether the consistency of the at least one flammable chemical substance is greater than a predefined value;
(c) upon the condition that the area meets the fire conditions, determining a fire position in the area according to planimetric position of the area, the temperature distribution, and the consistency of the at least one flammable chemical substance;
(d) analyzing chemistry of the flammable chemical substance according to the consistency, and selecting one fire extinguisher from the switching device; and
(e) controlling the fire extinguisher to extinguish the fire position.

2. The method as described in claim 1, further comprising:
sending fire alarm information to a fire-alarm that is electronically connected to the electronic device, upon the condition that the area meets the fire conditions; and
generating an alarm to forewarn of risk of fire by the fire-alarm.

3. The method as described in claim 2, further comprising steps after the step (e):
determining whether the area meets a fire suppression condition by monitoring the temperature distribution of the area and by monitoring the consistency of the flammable chemical substance;
recording the fire position, upon the condition the area meets the fire suppression condition; or
sending the fire alarm information to the fire-alarm to keep ringing and returning the step (e).

4. The method as described in claim 3, further comprising:
controlling the mobile platform to move to a safer place upon the condition that the fire extinguisher is fully discharged and the area does not meet the fire suppression condition.

5. The method as described in claim 1, wherein the mobile platform is driven by a motor, and is mounted on a track that is set above the area to be monitored.

6. An electronic device, comprising:
at least one processor;
a storage system; and
one or more modules that are stored in the storage system and executed by the at least one processor, the one or more modules comprising:
a control module operable to control a mobile platform to move along a predetermined path, the mobile platform comprising an infrared capturing device, a smoke detector, and one or more fire extinguishers, the infrared capturing device capturing a temperature distribution of an area monitored by an infrared capturing device, the smoke detector detecting consistency of at least one flammable chemical substance in the area;
a fire condition determining module operable to determine whether the area meets fire conditions by detecting whether the temperature distribution complies with a predetermined temperature distribution, or by detecting whether the consistency of the at least one flammable chemical substance is greater than a predefined value;
a fire position determining module operable to determine a fire position in the area according to planimetric position of the area, the temperature distribution, and the consistency of the at least one flammable chemical substance, upon the condition that the area meets the fire conditions;
a fire extinguisher selection module operable to analyze chemistry of the flammable chemical substance according to the consistency, and select one fire extinguisher from the switching device; and
a fire suppression module operable to control the fire extinguisher to extinguish the fire position.

7. The electronic device as described in claim 6, wherein the one or more modules further comprises:
an information transmission module operable to send fire alarm information to a fire-alarm that is electronically connected to the electronic device, upon the condition that the area meets the fire conditions.

8. The electronic device as described in claim 6, wherein the control module is further operable to re-sample the room, capture the temperature distribution of the area by using the infrared capturing device, and detect the consistency of the flammable chemical substance by using the smoke detector.

9. The electronic device as described in claim 8, wherein the fire condition determining module is further operable to determine whether the area meets a fire suppression condition according to the temperature distribution and the consistency.

10. The electronic device as described in claim 8, wherein the one or more modules further comprises a recording module operable to record the fire position upon the condition the area meets the fire suppression condition.

11. The electronic device as described in claim 8, wherein the control module is further operable to control the mobile platform to move to a safer place upon the condition that the fire extinguisher is fully discharged and the area does not meet the fire suppression condition.

12. The electronic device as described in claim 6, wherein the mobile platform is driven by a motor, and is mounted on a track that is set above the area to be monitored.

13. A mobile platform for monitoring an area being mounted on a track set above the area, the mobile platform comprising:
an infrared capturing device for capturing a temperature distribution of the area, upon the condition that the mobile platform is controlled to move along the track by an electronic device being electronically connected to the mobile platform;
a smoke detector for detecting smoke in the area, and detecting a consistency of at least one flammable chemical substance in the smoke, upon the condition that the mobile platform is controlled to move along the track; and
a switching device equipped with one or more fire extinguishers for extinguishing fire at a fire position detected by the electronic device, upon the condition that the temperature distribution does not comply with a predetermined temperature distribution, or the consistency of the at least one flammable chemical substance is greater than a predefined value.

14. The mobile platform as described in claim 13, wherein the electronic device is further connected to a firm alarm for receiving fire alarm information sent by the electronic device, and generating an alarm to fore warn of the risk of the fire.

15. The mobile platform as described in claim 13, wherein the electronic device is further operable to analyze chemistry of the flammable chemical substance according to the consistency, select one fire extinguisher from the switching device, and control the fire extinguisher to extinguish the fire position.

16. The mobile platform as described in claim 15, wherein the mobile platform is further controlled to move to a safer place, upon the condition that the fire extinguisher is fully discharged and the area does not meet a fire suppression condition.
